(19) United States
(12) Patent Application Publication
(10) Pub. No.: US 2014/0277884 A1
(43) Pub. Date: Sep. 18, 2014

(54) DRIVE SYSTEM AND METHOD FOR DRIVING A VEHICLE

(71) Applicant: General Electric Company, Schenectady, NY (US)

(72) Inventors: Ronghui Zhou, Shanghai (CN); Jian Zhou, Shanghai (CN); Fengcheng Sun, Shanghai (CN); Pengju Kang, Yorktown Heights, NY (US); Hai Qiu, Shanghai (CN); Fei Li, Shanghai (CN); Xiangming Shen, Shanghai (CN); Xi Lu, Shanghai (CN)

(73) Assignee: General Electric Company, Schenectady, NY (US)

(21) Appl. No.: 14/202,674

(22) Filed: Mar. 10, 2014

(30) Foreign Application Priority Data
Mar. 15, 2013 (CN) 201310084413.8

(51) Int. Cl. B60L 15/20

(52) U.S. Cl. CPC B60L 15/20
USPC 701/22; 701/1

(57) ABSTRACT

A drive system includes a control unit and a traction device. The control unit is configured to receive a load variation signal indicating a vehicle load is to be or being changed and generate a traction torque in response to the load variation signal. The traction device is coupled to the control unit and configured to drive a vehicle according to the traction torque.

### BACKGROUND

Embodiments of the invention relate generally to a drive system and a method, and more particularly relate to a drive system and a method for adjusting a traction torque to drive a vehicle while a vehicle load is changed.

Vehicles can be equipped with a multitude of loads including electrical loads, such as air conditioning systems, hydraulic pumps, and mechanical loads, such as power take-off (PTO) implements, for performing different functions. For example, agricultural or industrial vehicles, such as tractors, forklifts, can be equipped with a multitude of different working or planting implements, such as PTO implements, hydraulic pumps, for different agricultural or industrial working functions. Currently, the traction of the vehicle is affected by the variation of the loads which may result in the speed variation of the vehicle. For example, an abrupt load variation may cause a rush-out problem during navigating or U-turning so as to affect the performance and safety of the vehicle.

It is desirable to provide a drive system and a method to address at least one of the above-mentioned problems.

### BRIEF DESCRIPTION

In accordance with one embodiment disclosed herein, a drive system is provided. The drive system includes a control unit and a traction device. The control unit is configured to receive a load variation signal indicating a vehicle load is to be or being changed and generate a traction torque in response to the load variation signal. The traction device is coupled to the control unit and configured to drive a vehicle according to the traction torque.

In accordance with another embodiment disclosed herein, a method is provided. The method includes receiving a load variation signal indicating a vehicle load is to be or being changed. The method further includes generating a traction torque in response to the load variation signal. And the method further includes applying the traction torque to a traction device to drive a vehicle according to the traction torque.

In accordance with another embodiment disclosed herein, a drive system is provided. The drive system includes a traction device and a control unit. The traction device is configured to provide different fraction torques to drive a vehicle. The control unit is configured to receive a load variation signal indicating that the vehicle is to be or being switched from a first load condition to a second load condition. The control unit is further configured to change a first traction torque generated corresponding to the first load condition to a second traction torque generated corresponding to the second load condition.

### DRAWINGS

These and other features and aspects of the present disclosure will become better understood when the following detailed description is read with reference to the accompanying drawings in which like characters represent like parts throughout the drawings, wherein:

FIG. 1 is a schematic diagram of a drive system for driving a vehicle in accordance with an embodiment;

FIG. 2 is a schematic diagram of the drive system in accordance with another embodiment; and

FIG. 3 is a flow chart of a method for driving the vehicle in accordance with an embodiment.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a”, and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

FIG. 1 illustrates a schematic diagram of a drive system 100 for a vehicle, particularly an agricultural or industrial vehicle, in accordance with an embodiment. The vehicle may be an electric vehicle, a hybrid vehicle or a vehicle powered by any other sources. The drive system 100 includes a control unit 11 and a traction device 13. In this embodiment, the drive system 100 further includes an instruction device 15 and a load drive device 17.

The load drive device 17 is configured to drive a vehicle load 19 which, in this embodiment, may be a power take-off (PTO) implement, for performing working functions, such as plowing and tilling. In some embodiments, the vehicle load 19 may include a hydraulic pump configured to perform lifting, an air conditioning device or any other devices configured to perform working functions. The vehicle load 19 may be an electrical load, such as the hydraulic pump and the air conditioning device, or a mechanical load, such as the PTO implement.

In this embodiment, the load drive device 17 includes a first electrical machine 171 configured to drive the vehicle load 19, and a PTO shaft 173 coupled to the first electrical machine 171 to carry the vehicle load 19. The first electrical machine 171 is capable of operating both as a motor and a generator. The first electrical machine 171, in this embodiment, may operate as a motor which is configured to drive the vehicle load 19 and powered by a power supply 21. The power supply 21, in this embodiment, may be a battery or any of other direct current (DC) sources to provide a DC. The power supply 21 provides power to the first electrical machine 171 through an inverter 23. In some embodiments, the power supply 21 may be an alternating current (AC) source or any other power sources. In some embodiments, the load drive device 17 may be other devices to drive the vehicle load, such as engine.

The instruction device 15 is configured to instruct the operation of the vehicle load 19 and provide a load variation signal to the control unit 11. The load variation signal is an instruction signal which instructs the vehicle load 19 to start to work, stop working or change working modes, and also a signal which indicates that the vehicle is to be or being switched from a first load condition to a second load condition. For example, the PTO implement is controlled to lift up or put down once the instruction device 15 is operated by a user, so that the load that the vehicle drives is decreased or increased. In some embodiments, the instruction device 15 may be an on/off switch, a pull bar, a button, an input panel or any other devices operated by users to input instruction signals. In some embodiments, two or more than two instruction devices 15 are provided to instruct different vehicle loads. The instruction devices 15 may generate different load variation signals for different vehicle loads.

The control unit 11 is configured to receive the load variation signal indicating the vehicle load 19 is to be or being changed. In this embodiment, the control unit 11 receives the load variation signal from the instruction device 15, so as to achieve the performance without increasing the hardware cost of the drive system 100. The control unit 11 is further configured to generate a traction torque in response to the load variation signal. In this embodiment, the control unit 11 generates a load variation torque in response to the load variation signal and further generates the traction torque based on the load variation torque and a vehicle command torque. The vehicle command torque, in this embodiment, may be input via an accelerator pedal 25, which indicates the amount of driver's pedal effort on the accelerator pedal 25. In some embodiments, the vehicle command torque is generated by the control unit 11 during automatic driving. The load variation torque indicates the variation amount of the torque supplied to the vehicle load 19 from the first load condition to the second load condition.

The traction torque is generated by adjusting the vehicle command torque with the load variation torque in order to compensate for the load change. More specifically, the traction torque is generated by increasing the vehicle command torque when the load variation torque has a positive value (i.e., the vehicle load is increased), or generated by decreasing the vehicle command torque when the load variation torque has a negative value (i.e., the vehicle load is decreased). The traction torque is determined and provided to the vehicle before or during the vehicle load 19 is changed so as to make sure the performance and the stability of the vehicle even if the load condition is changed. For example, it avoids the vehicle rushing out or pausing during traveling while the vehicle load 19 is changed. In this embodiment, multiple values of the load variation torque corresponding to the different load variation signals for different load variation condition are pre-detected or pre-estimated, which may be mapped in a mapping table. The corresponding value of the load variation torque may be looked out from the mapping table according to the load variation signal to calculate the traction torque, so as to increase the computation rate of the control unit 11 and the reaction rate of the drive system 100.

The control unit 11 is configured to determine a torque range having a lower limit value and an upper limit value in response to the load variation signal and to limit the traction torque within the torque range. The lower limit value indicates a lowest safeguard torque of the traction torque and the upper limit value indicates a highest safeguard torque of the traction torque. The torque range is determined based at least on the total load amount of the vehicle. The torque range, in this embodiment, is adjusted based on the load variation torque. In this embodiment, the control unit 11 determines the torque range based on the load variation torque and a pre-set range. Before the vehicle load 19 is changed, the traction torque is limited within the pre-set range which has a lower limit value and an upper limit value. The traction torque is limited within the torque range once the vehicle load 19 is changed, so as to make sure the safety of the vehicle. The torque range is determined by adjusting the pre-set range with the load variation torque. More specifically, the torque range is generated by extending the pre-set range when the load variation torque has a positive value (i.e., the vehicle load is increased), and by narrowing the pre-set range when the load variation torque has a negative value (i.e., the vehicle load is decreased). The lower limit value and the upper limit value of the torque range are adjusted based on the lower limit value and the upper limit value of the pre-set range and the load variation torque to adapt to the variation of the vehicle load 19.

The vehicle is working in the first load condition before the vehicle load 19 is changed. The control unit 11 generates a first fraction torque corresponding to the first load condition to drive the vehicle in the first load condition. While the vehicle load 19 is changed, the vehicle is switched from the first load condition to the second load condition, and the control unit 11 changes the first traction torque to a second traction torque generated corresponding to the second load condition in response to the load variation signal. In one embodiment, the second traction torque may be determined based on the first traction torque and the load variation torque. The second traction torque is determined by adjusting the first fraction torque with the load variation torque. In another embodiment, the second traction torque may be determined based on the vehicle command torque and the load variation torque as what mentioned previously.

The traction device 13 is coupled to the control unit 11 and configured to drive the vehicle according to the fraction torque. The fraction device 13 is configured to provide different fraction torques, such as the first traction torque and the second traction torque, to drive the vehicle. The fraction device 13 provides the first traction torque to drive the vehicle working in the first load condition before the vehicle load 19 is changed. The traction device 13 provides the second traction torque to drive the vehicle working in the second load condition when the vehicle load 19 is changed.

In this embodiment, the traction device 13 includes a second electrical machine 131 configured to drive the vehicle. The second electrical machine 131 is coupled via a drive draft 133 to a vehicle transmission 27 which is attached by wheels (not shown). The second electrical machine 131 is capable of operating both as a motor and a generator. The second electrical machine 131, in this example, may operate as a motor which is configured to drive the vehicle transmission 27 and powered by the power supply 21. The power supply 21 provides power to the second electrical machine 131 through an inverter 29. In some embodiments, the traction device 13 may include other devices to drive the vehicle transmission 27, such as engine.

FIG. 2 illustrates a schematic diagram of a drive system 200 in accordance with another embodiment. The drive system 200 of the embodiment in FIG. 2 is similar to the drive system 100 of the embodiment in FIG. 1. Compared to the embodiment of FIG. 1, the drive system 200 illustrated in FIG. 2 includes one or more load detection sensors 31 configured to detect a load variation condition of the vehicle load 19 and generate the load variation signal to the control unit 11 according to the load variation condition. The load detection sensors 31 detect a first operation parameter, such as acceleration of the PTO shaft 173, current and voltage, and generate the load variation signal according to the first operation parameter. In some embodiments, the detection sensors 31 may be further configured to detect a second operation parameter, such as velocity of the PTO shaft 173, current and voltage, and generate an operation signal indicating the amount of the load variation according to the second operation parameter. In this embodiment, the control unit 11 may calculate the load variation torque based on the operation signal in response to the load variation signal. The load variation torque, in this embodiment, may be calculated accurately due to the load detection sensors 31. In some embodiments, the load detection sensors 31 may include an accelerometer, a gyroscope, a current sensor, a voltage sensor and/or any other detection devices.

FIG. 3 illustrates a flow chart of a method 300 in accordance with an embodiment. While the actions of the method 300 are illustrated as functional blocks, the order of the blocks and the separation of the actions among the various blocks shown in FIG. 3 are not intended to be limited. For example, the blocks may be performed in a different order and an action associated with one block may be combined with one or more other blocks or may be sub-divided into a number of blocks.

At block 40, a load variation signal of the vehicle load is received. The load variation signal indicates the vehicle load is to be or being changed. In one embodiment, the load variation signal which instructs the operation of the vehicle load is generated via one or more instruction devices 15 shown in FIG. 1. In another embodiment, a load variation condition of the vehicle load is detected via one or more load detection sensors 31 shown in FIG. 2, and the load variation signal is generated via the load detection sensors 31 according to the load variation condition.

A traction torque is generated in response to the load variation signal that, in this embodiment, includes actions at blocks 42 and 44. At block 42, a load variation torque is generated in response to the load variation signal. The load variation signal may be generated through the look-up table method, estimation in real-time, or any other methods. At block 44, the traction torque is generated based on the load variation torque and a vehicle command torque. The vehicle command torque may be input via the accelerator pedal 25 by drivers or generated by the control unit 11 in automatic control condition. The traction torque is generated by adjusting the command torque with the load variation torque.

At block 46, a torque range having a lower limit value and an upper limit value is determined in response to the load variation signal. The torque range is adjusted based on the load variation torque. The torque range is determined by adjusting a pre-set range with the load variation torque. At block 48, the traction torque is limited within the torque range to make sure the safety of the vehicle. At block 50, the traction torque is applied to a traction device to drive a vehicle according to the traction torque.

While embodiments of the invention have been described herein, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

1. A drive system, comprising:
a control unit configured to receive a load variation signal indicating a vehicle load is to be or being changed and generate a fraction torque in response to the load variation signal; and
a traction device coupled to the control unit and configured to drive a vehicle according to the traction torque.

2. The drive system of claim 1, further comprising one or more instruction devices configured to instruct the operation of the vehicle load and provide the load variation signal to the control unit.

3. The drive system of claim 1, further comprising one or more load detection sensors configured to detect a load variation condition of the vehicle load and generate the load variation signal to the control unit according to the load variation condition.

4. The drive system of claim 1, wherein the control unit is configured to generate a load variation torque in response to the load variation signal and generate the traction torque based on the load variation torque and a vehicle command torque.

5. The drive system of claim 1, wherein the control unit is configured to determine a torque range having a lower limit value and an upper limit value in response to the load variation signal and limit the traction torque within the torque range.

6. The drive system of claim 5, wherein the control unit is configured to generate a load variation torque in response to the load variation signal and adjust the torque range based on the load variation torque.

7. The drive system of claim 1, wherein the drive system comprises a first electrical machine configured to drive the vehicle load, and the traction device comprises a second electrical machine configured to drive the vehicle.

8. A method, comprising:
receiving a load variation signal indicating a vehicle load is to be or being changed;
generating a traction torque in response to the load variation signal; and
applying the traction torque to a traction device to drive a vehicle according to the fraction torque.

9. The method of claim 8, further comprising generating, via one or more instruction devices, the load variation signal instructing the operation of the vehicle load.

10. The method of claim 8, wherein receiving the load variation signal comprises detecting, via one or more load detection sensors, a load variation condition of the vehicle load and generating the load variation signal according to the load variation condition.

11. The method of claim 8, wherein generating the traction torque comprises:
generating a load variation torque in response to the load variation signal; and
generating the traction torque based on the load variation torque and a vehicle command torque.

12. The method of claim 8, further comprising determining a torque range having a lower limit value and an upper limit value in response to the load variation signal and limiting the traction torque within the torque range.

13. The method of claim 12, wherein determining the torque range comprises generating a load variation torque in response to the load variation signal and adjusting the torque range based on the load variation torque.

14. A drive system, comprising:
a traction device configured to provide different traction torques to drive a vehicle; and
a control unit configured to receive a load variation signal indicating that the vehicle is to be or being switched from a first load condition to a second load condition, the control unit further configured to change a first traction torque generated corresponding to the first load condition to a second traction torque generated corresponding to the second load condition.

15. The drive system of claim 14, further comprising one or more instruction devices configured to instruct the operation of a vehicle load and provide the load variation signal to the control unit.

16. The drive system of claim 14, further comprising one or more load detection sensors configured to detect a load variation condition of the vehicle load and generate the load variation signal to the control unit according to the load variation condition.

17. The drive system of claim 14, wherein the control unit is configured to generate a load variation torque in response to the load variation signal and generate the second traction torque based on the first traction torque and the load variation torque.

18. The drive system of claim 14, wherein the control unit is configured to determine a torque range having a lower limit value and an upper limit value in response to the load variation signal and limit the second traction torque within the torque range.

19. The drive system of claim 18, wherein the control unit is configured to generate a load variation torque in response to the load variation signal and adjust the torque range based on the load variation torque.

20. The drive system of claim 14, wherein the drive system comprises a first electrical machine configured to drive a vehicle load, and the traction device comprises a second electrical machine configured to drive the vehicle.
